(19) United States
(12) Patent Application Publication
(10) Pub. No.: US 2005/0202102 A1
(43) Pub. Date: Sep. 15, 2005

(54) Biocidal formulation and methods for the preparation thereof

(76) Inventor: Zvi Miller, Tivon (IL)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/515,815

(22) PCT Filed: Jun. 2, 2003
(86) PCT No.: PCT/IL03/00461

§ 371 Date: Nov. 26, 2004

(30) Foreign Application Priority Data
Jun. 2, 2002 (IL) 149978

(51) Int. Cl. A61K 35/78; A61K 33/06; A61K 31/14

(52) U.S. Cl. 424/682; 424/770; 514/642

(57) ABSTRACT

A novel biocide of sustained biocidical activity is hereto provided. This cost-effective biocide composition comprising water-immiscible acidic oil, a magnesium salt and an amine. The present invention also provides a method for the production of the biocide, comprising the steps of solubilizing the amine in the oil and than sufficiently admixing the magnesium salt, until homogenous suspension is obtained.

### FIELD OF THE INVENTION

The present invention relates to a biocide and to a method for making the same. More specifically, the present invention relates to a composition especially useful as fungicide and to coating and paint comprising said biocide.

### BACKGROUND OF THE INVENTION

Biocides and especially fungicides are widely known in the every day practice for centuries. Nevertheless, many efforts were invested in the last few decades to produce biocidic compositions that are non-toxic to humans and to the environment. Nevertheless, an effective biocide comprising long term activity is yet rarely found. Hence, U.S. Pat. No. 5,654,012 to Lutey presents a method for controlling and reducing the growth of microorganisms by using borate salts. Composition made by the said method is considerably effective, by characterized by a relatively high solubility coefficients, thus escape from the biocide composition at a respectively short period of time. E.P. Pa No. 10,237,247 to Nakazawa and other presents zinc oxide salts as the active component in a biocide composition of reasonable stability, yet proved as biocides of relatively low affectivity. Similarly, compositions comprising quaternary amine as the active ingredient of the biocide show high solubility in aqueous phases thus are not suitable for systems adapted to a sustained activity.

U.S. Pat. No. 2,818,344 discloses paint having within it as a biocidal agent barium borate salt having a very specific range of barium borate. While products produced according to this patent were used in the 60's, during the lasr decade, with the realization of the toxicity and hazardous environmental effects of these products there use has almost completely ceased.

### SUMMARY OF THE INVENTION

It is thus the purpose of the present invention to provide a useful composition adapted to sustained biocidical activity. According to one preferred embodiment of the present invention, the said water-immiscible acidic oil is selected from Tall oil, naphthenic acid, paraffin oil, oleic acid or any other acidic compound soluble in the organic phase. The magnesia salt is preferably selected from magnesium oxide, denoted also as magnesia, magnesium hydroxide, magnesium chloride, magnesium sulfate or mixture thereof, including, yet not limited to Sorel like composition. In particularly, biocide compositions comprising inter alia mixtures of magnesia with magnesium sulfate and/or magnesia with magnesia chloride are found most effective.

According to another preferred embodiment of the present invention, the aforementioned biocide comprises of quaternary amine, and particularly quaternary amine selected from the commercial available Cetrimide and/or the commercial available Querton products or any mixture thereof. Yet, the said amine may be chosen from other amine type, such as primary amine, and more specifically, form monoethyl amine, monoethanol amine, melamine or mixture thereof.

According to another preferred embodiment of the present invention, the aforementioned biocide additionally comprises at least one additive. More specifically, said additive is selected from at least one borate salt, zinc salt, cooper salt or any mixture thereof, and particularly one oxide, selected form borax boric acid, metaborate, zinc oxide, or cooper oxide or any mixture thereof.

Still according to yet another embodiment of the present invention, said additive is selected from a colorant (namely colorant, dye, pigment, UV stabilizer, UV blocker, UV enhancer etc.), an anti-corrosive pigments of any kind, and preferably inorganic or organic compositions comprising magnesium salts as the active ingredient; a stabilizer, surface active agent or any other suitable means adapted to enable the dispersion or the solubilization of said biocide in paint or coating, or any mixture thereof.

It is also in the scope of the present invention to provide useful paint or coating comprising an effective amount of the biocide as defined in the present invention.

Another main object of the invention is to provide a useful method for the production of the biocide defined above. Said method is generally comprises the following step; (a) solubilizing the amine in the oil; and then (b) sufficiently admixing the magnesium salt in the mixture obtained in step (a) until homogenous suspension is obtained.

According one preferred embodiment of the present invention, the method defined above additionally comprises the steps of drying the obtained suspension so a dried powder is obtained. Additionally or alternatively, said method may comprise a step of milling the obtained dried powder until homogeneous powder of predetermined particle size is obtained. More specifically, the solution comprising the amine and the oil is heated to more then 50° C.

According to another preferred embodiment of the present invention, the method defined above additionally comprises the steps of (a) admixing the magnesium salt with the amine, preferably while heating to more then 50° C.; and than (b) suspending the obtained admixture in the oil. In additional step, at least one additive is admixed.

### DETAILED DESCRIPTION OF THE INVENTION

The following description is provided, along all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide the biocide and the method for its production as defined and described below.

It is thus in the scope of the present invention to provide an effective biocide adapted for sustained activity of regulating and inhibiting growth of biological species. Said biocide is generally comprising three main ingredients: water-immiscible acidic oil of relatively high molecular weight; a manesium salt and an amine.

The term ‘biocide’ is defined in the present invention to a composition proved useful as fungicide, algaecide, herbicide, insecticide, or bactericide.

The biocide defied above is preferably comprising 3 to 10% (wt) water-immiscible acidic oil; 30-60% (wt) magnesium salt; 1.5 to 12% amine and 30 to 70% water According to one preferred embodiment of the present invention, the biocide comprises (weight percent of the main ingredients is) about 3% (wt) water-immiscible acidic oil; 44 (wt) magnesium oxide and 3% Querton 246.

The biocides according to the present invention was proved useful in the method defined below, wherein the term Biotan C is referring for a Cetrimide containing composition; the term Citramide B is referring for a Cetimide plus magnesium sulfate salt containing composition; the tern Cetrimide is referring for a composition comprising the commercial available Cetrimide without magnesium sulfate; wherein weight percent, such as 5% or 9%, refers to the weight percent of the active ingredient in the biocide; and the same for the terms of Biotan Q, referring to biocides comprising the various commercial available Querton products.

The nomenclature of the various biocides is set forth: Biotan C is denoted for biocides comprising cetrimide: Cetrimide B 5% is referring to Biotan C with 5% cetrimide, comprising magnesium sulfate and magnesium oxide. Cetrimide 5% is referring to Biotan C with 5% cetrimide, containing magnesium oxide without the presence of magnesium sulfate. The same for biocide comprises 9% cetrimide. Biotan Q is denoted for biocides comprising at lest one Querton product: Querton.B.5% is referring to Biotan Q with 5% Querton, comprising magnesium sulfate and magnesium oxide. Querton B 5% is referring to Biotan Q with 5% Querton, containing magnesium oxide without addition of magnesium sulfate. The same is for biocide comprising 9% Querton.

Reference is made now to table 1, presenting a plurality of control experiments, which is the effect of various biocide compositions on the growth of fungi along a predetermined period of time wherein said fungi was kept in an incubator. Table 1 is hence presenting the effect of various biocide compositions on the growth of common fungi, as such as Aspergillus niger. It is acknowledged that in the concentration range of 1.5-4.5% Cetrimide and Querton are effective at any time scale according to known in the art ASTM methods wherein self test named BLANC and SID, referring here to a synthetic lime wash: following using a filter paper without using pigment and colorant agent; and with using a filter paper with a colorant without a pigment, respectively.

TABLE 1
The effect of various biocide compositions on the growth of fungi along a
predetermined period of time wherein said fungi was kept in an incubator.

| | Conc. | | | | | | | | | | | | | | |
|---|---|---|---|---|---|---|---|---|---|---|---|---|---|---|---|
| | 1.5% | | | | | 3.0% | | | | | 4.5% | | | | |
| | Days | | | | | | | | | | | | | | |
| | 2 | 4 | 6 | 8 | 10 | 2 | 4 | 6 | 8 | 10 | 2 | 4 | 6 | 8 | 10 |
| BLANK | 4 | | | | | 4 | | | | | 4 | | | | |
| SID | 4 | | | | | 4 | | | | | 4 | | | | |
| CETRIMIDE.B - 9% | 0 | 0 | 0 | 0 | 0 | 0 | 0 | 0 | 0 | 0 | 0 | 0 | 0 | 0 | 0 |
| CETRIMIDE - 9% | 0 | 0 | 0 | 0 | 0 | 0 | 0 | 0 | 0 | 0 | 0 | 0 | 0 | 0 | 0 |
| QUERTON.B - 9% | 0 | 0 | 0 | 0 | 0 | 0 | 0 | 0 | 0 | 0 | 0 | 0 | 0 | 0 | 0 |
| QUERTON - 9% | 0 | 0 | 0 | 0 | 0 | 0 | 0 | 0 | 0 | 0 | 0 | 0 | 0 | 0 | 0 |

Table 2 presents the same after one hour immersion in water, hence determining the washing effect or the solubility of the biocide in the short term. Hence, Table 2 is presenting that at the concentration of 1.5%, Querton B-5% and Querton-5% were the most effective biocides. At the 3% to 4.5% concentration range, however, all biocides are effective, excluding Querton B 9% at the said 3% range.

TABLE 2
The effect of the biocide compositions on the growth of fungi after one-hour immersion in
water. Table 2 presents the washing effect or the solubility of the biocide in the short term.

| | Conc. | | | | | | | | | | | | | | |
|---|---|---|---|---|---|---|---|---|---|---|---|---|---|---|---|
| | 1.5% | | | | | 3.0% | | | | | 4.5% | | | | |
| | Days | | | | | | | | | | | | | | |
| | 2 | 4 | 6 | 8 | 10 | 2 | 4 | 6 | 8 | 10 | 2 | 4 | 6 | 8 | 10 |
| BLANK | 4 | | | | | 4 | | | | | 4 | | | | |
| SID | 4 | | | | | 4 | | | | | 4 | | | | |
| CETRIMIDE B 5% | 1 | 1 | 1.5 | 2 | 2 | 0 | 0 | 0 | 0 | 0 | 0 | 0 | 0 | 0 | 0 |
| CETRIMIDE B 9% | 1 | 1.5 | 1.5 | 2 | 2.5 | 1 | 1 | 1 | 1.5 | 1.5 | 0 | 0 | 0 | 0 | 0 |
| CETRIMIDE 5% | 1 | 1.5 | 2 | 2 | 2.5 | 0 | 0 | 0 | 0 | 0 | 0 | 0 | 0 | 0 | 0 |
| CETRIMIDE 9% | 0 | 0 | 0 | 0 | 0 | 0 | 0 | 0 | 0 | 0 | 0 | 0 | 0 | 0 | 0 |
| QUERTON B 5% | 0 | 0 | 0 | 0 | 0 | 0 | 0 | 0 | 0 | 0 | 0 | 0 | 0 | 0 | 0 |
| QUERTON B 9% | 0 | 0 | 0 | 0 | 0 | 0 | 0 | 0 | 0 | 0 | 0 | 0 | 0 | 0 | 0 |
| QUERTON 5% | 0 | 0 | 0 | 0 | 0 | 0 | 0 | 0 | 0 | 0 | 0 | 0 | 0 | 0 | 0 |
| QUERTON 9% | 0 | 0 | 0 | 0 | 0 | 0 | 0 | 0 | 0 | 0 | 0 | 0 | 0 | 0 | 0 |

Table 3 presents the same after a plurality of ton one-hour immersions in water hence determining the washing effect or the solubility of the biocide in significantly long run. Table 3 is presenting thus that at 1.5% any of the biocides is not effective, wherein Cetrimide 9% is the most effective composition. All the compositions comprising Cetrimide are better then those containing Querton. At 3%, the Cetrimide-5% is the better, and at 4.5% Quentom 5% and Querton B 5% and all cetrimide containing biocides are perform well.

TABLE 3
The effect of the biocide compositions on the growth of fungi after a ten one-
hour immersions in water. Table 3 determines the washing effect or the
solubility of the biocide in significantly long run.

| | Conc. | | | | | | | | | | | | | | |
|---|---|---|---|---|---|---|---|---|---|---|---|---|---|---|---|
| | 1.5% | | | | | 3.0% | | | | | 4.5% | | | | |
| | Days | | | | | | | | | | | | | | |
| | 2 | 4 | 6 | 8 | 10 | 2 | 4 | 6 | 8 | 10 | 2 | 4 | 6 | 8 | 10 |
| BLANK | 4 | | | | | 4 | | | | | 4 | | | | |
| SID | 4 | | | | | 4 | | | | | 4 | | | | |
| CETRIMIDE B 5% | 2 | 3 | 3 | 3.5 | 3.5 | 1 | 1.5 | 1.5 | 2 | 2 | 0 | 0 | 0 | 0 | 0 |
| CETRIMIDE B 9% | 1.5 | 2.5 | 3 | 3.5 | 3.5 | 0 | 1 | 1 | 1.5 | 2 | 0 | 0 | 0 | 0 | 0 |
| CETRIMIDE 5% | 1 | 1.5 | 2 | 2 | 2.5 | 0 | 0 | 0 | 0 | 0 | 0 | 0 | 0 | 0 | 0 |
| CETRIMIDE 9% | 1 | 2 | 2 | 2.5 | 2.5 | 1.5 | 2.5 | 2.5 | 2.5 | 3 | 0 | 0 | 0 | 0 | 0 |
| QUERTON B 5% | 3 | 3.5 | 3.5 | 4 | | 1 | 1.5 | 1.5 | 2 | 2 | 0 | 0 | 0 | 0 | 0 |
| QUERTON B 9% | 4 | | | | | 3.5 | 3.5 | 4 | | | 1 | 1 | 1.5 | 1.5 | 2 |
| QUERTON 5% | 4 | | | | | 1 | 2 | 2 | 2.5 | 2.5 | 0 | 0 | 0 | 0 | 0 |
| QUERTON 9% | 3.5 | 4 | | | | 1.5 | 2 | 2.5 | 3 | 3 | 0 | 1 | 1.5 | 1.5 | 1.5 |

Table 4 presents the same after a two-week period immersion in water, hence determining the washing effect or die solubility of the biocide in a very long run. Table 4 is thus presenting that at the 1.5% non of the tested biocide perform well, wherein the Cetimide B. −9% and Cetrimide −9% are better. Much similar are the results at 3% to 4,5%, wherein the Querton based compositions were less effective.

TABLE 4
The effect of the biocide compositions on the growth of fungi after a two-week
period immersion in water. Table 4 shows the washing effect or the solubility
of the biocide in a very long run.

| | Conc. | | | | | | | | | | | | | | |
|---|---|---|---|---|---|---|---|---|---|---|---|---|---|---|---|
| | 1.5% | | | | | 3.0% | | | | | 4.5% | | | | |
| | Days | | | | | | | | | | | | | | |
| | 2 | 4 | 6 | 8 | 10 | 2 | 4 | 6 | 8 | 10 | 2 | 4 | 6 | 8 | 10 |
| BLANK | 4 | | | | | 4 | | | | | 4 | | | | |
| SID | 4 | | | | | 4 | | | | | 4 | | | | |
| CETRIMIDE B 9% | 1 | 1.5 | 2 | 2.5 | 3.5 | 0 | 0 | 0 | 0 | 0 | 0 | 1 | 1.5 | 1.5 | 2 |
| CETRIMIDE 9% | 1 | 1.5 | 2 | 2 | 2.5 | 0 | 0 | 0 | 0 | 0 | 0 | 1 | 1 | 1 | 1 |
| QUERTON B 9% | 4 | | | | | 4 | | | | | 3 | 3.5 | 3.5 | 3.5 | 3.5 |
| QUERTON 9% | 4 | | | | | 3.5 | 3.5 | 4 | | | 3.5 | 4 | 1.5 | 1.5 | 1.5 |

1. A biocide of sustained biocidical activity, comprising water-immiscible acidic oil, a magnesium salt and an amine.

2. The biocide according to claim 1, comprising 3 to 10% (wt) said water-immiscible acidic oil, selected from Tall oil, naphthenic acid, paraffin oil.

3. The biocide according to claim 1, comprising 30 to 60% (wt) said magnesium salt, selected from magnesium oxide, magnesium hydroxide, magnesium chloride, magnesium sulfate, Sorel like compositions or any mixture thereof.

4. The biocide according to claim 1, wherein the amine is quaternary amine in the range of 1.5 to 12% (wt).

5. The biocide according to claim 4, wherein the quaternary amine is selected from Cetramide, Querton or a mixture thereof.

6. The biocide according to claim 1, wherein the amine is primary amine.

7. The biocide according to claim 6, wherein the primary amine is selected from monoethyl amine, monoethanol amine, melamine or a mixture thereof

8. The biocide according to claim 1, additionally comprising at least one additive.

9. The biocide according to claim 8, wherein the additive is selected from at least one borate salt, zinc salt, cooper salt or any mixture thereof.

10. The biocide according to claim 8, wherein the additive is selected from at least one oxide selected of borate, zinc, cooper or any mixture thereof.

11. The biocide according to claim 8, wherein the additive is selected from a colorant, an anti-corrosive pigment, a stabilizer or any other suitable means to enable the dispersion or solubilization of said biocide in paint or coating, or any mixture thereof.

12. The biocide as defined in claim 1, adapted to provide at least one characteristics selected from the group of fungicide, algaecide, herbicide, insecticide, or bactericide.

13. A paint or coating comprising an effective amount of the biocide as defined in claim 1.

14. A method for the production of the biocide according to claim 1, comprising;
a. solubilizing the amine in the oil; and,
b. sufficiently admixing the magnesium salt until homogenous suspension is obtained.

15. The method according to claim 14, additionally comprising drying the obtained suspension so a dried powder is obtained.

16. The method according to claim 14, additionally comprising milling the obtained dried powder until homogeneous powder of predetermined particle size is obtained.

17. The method according to claim 14, additionally comprising drying the obtained suspension so a dried powder is obtained.

18. The method according to claim 14, additionally comprising heating the solution comprising the amine and the oil to more then 50 C.

19. The method according to claim 14, comprising;
a. admixing the magnesium salt with the amine; and,
b. suspending the obtained admixture in the oil.

20. The method according to claim 19, additionally comprising heating the suspension obtained in step b to more then 50° C.

21. The method as defined in claim 14, comprising the step of admixing of at least one additive.
